(19) United States
(12) Patent Application Publication
(10) Pub. No.: US 2004/0120484 A1
(43) Pub. Date: Jun. 24, 2004

(54) Telephonic interface for a visual presentation of a hierarchy of menus and automated call-back

(75) Inventor: J. M. Buzbee, Mineral Wells, TX (US)

Correspondence Address: CARR LAW FIRM, L.L.P., 670 FOUNDERS SQUARE, 900 JACKSON STREET, DALLAS, TX, 75202, US

(73) Assignee: J. M. Buzbee Family Limited Partnership, Mineral Wells, TX (US)

(21) Appl. No.: 10/685,217

(22) Filed: Oct. 14, 2003

Related U.S. Application Data
(63) Continuation-in-part of application No. 10/326,623, filed on Dec. 20, 2002.

(51) Int. Cl. H04M 1/64; H04M 11/00

(52) U.S. Cl. 379/93.17; 379/88.01

(57) ABSTRACT

The present invention provides for a telephone caller response and option selection. An interface system provides to a telephone caller a visual representation of a hierarchy of one or more menus. A caller phone is employable to select at least one option from the visual representation of a hierarchy of menus provided by the telephone interface system. A caller computer is employable to receive the visual representation of a hierarchy of menus from the interface system. A caller monitor is employable to display the visual representation of a hierarchy of menus, thereby avoiding the more time consuming presentation of the hierarchy of menus in an oral fashion. The interface system is further employable to reconnect with a telephone caller at a later time if the telephone caller is to wait in a queue of the interface system longer than a specified time.

### RELATED APPLICATIONS

The present Application is a Continuation-in-Part of “Telephonic Interface for a Visual Presentation of a Hierarchy of Menus,” U.S. Ser. No. 10/326,623 filed Dec. 20, 2002.

### TECHNICAL FIELD

The invention relates generally to a telephone system and, more particularly, to a telephone system providing caller options in one or more visual menus or other representations.

### BACKGROUND

Telecommunications is becoming increasingly important in the modern world and workplace. However, providing an individual to interact with a caller is costly. More and more businesses, government agencies and other content providers are therefore eliminating receptionists and a human operator. An automated telephone system can instead be employed to interface with the caller. These interfaces typically employ a menu having a plurality of hierarchy levels. In other words, a choice of “a,” “b” or “c” can each lead to a further plurality of choices.

Typically, in conventional telephonic interface systems, an oral communication is made to the caller, with all of the possible choices orally disclosed, after which a choice can be made by the caller. This generally leads to another sequence of choices. This choosing of menu selections in the hierarchy can go on for a number of levels before the caller arrives at the choice of interest. This can be time-consuming and generally frustrating to the caller. Furthermore, the oral presentation can also contain commercial, instruction and cautionary messages which can also slow the process of menu item selection. However, even if the caller eventually interacts with a human operator instead of interacting with prompts from a computer system, typically the caller has navigated through a lengthy menu of choices, most of which are not relevant to the caller's interest.

Furthermore, when a caller contacts an automated telephone system, the caller can be put on hold if the computer of the automated telephone system can not immediately service the caller. The caller can be told an estimation of how much longer he or she has to wait in queue until he is served. Waiting in the queue can be aggravating to the caller. However, if the caller instead decides to phone again later so as to be serviced at a later time when there could be a shorter queue, typically the caller is put back at the end of the queue then existing. This can also be aggravating to the caller. Alternatively, if the caller would have otherwise been waiting in a queue of greater than a threshold duration, the caller is told to try to call again at a later time and is disconnected by the automated telephone system. This can also be aggravating to the caller.

Therefore, a presentation of telephonic hierarchical selections is needed that overcomes some of the shortcomings of conventional presentations of telephonic hierarchical selections. There is a further need to respond to a caller in a queue of an automated telephone system that overcomes some of the shortcomings of conventional automated telephone queuing.

### SUMMARY

The present invention provides for a telephone caller response and option selection. An interface system provides to a telephone caller a visual representation of a hierarchy of one or more menus. The interface system is further employable to disconnect from the caller phone and to call the telephone caller at a later point in time. A caller phone is employable to select at least one option from the visual representation of a hierarchy of menus provided by the telephone interface system. A caller computer is employable to receive the visual representation of a hierarchy of menus from the interface system. A caller monitor is employable to display the visual representation of a hierarchy of menus.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 schematically depicts a system for obtaining and display of a visual representation of a hierarchical menu;

FIG. 2 is a Nodal Analysis diagram illustrating a signal flow from a calling phone requesting a visual hierarchical representation of menus;

FIG. 3 is a Nodal Analysis diagram illustrating a signal flow from a provider computer to notify a caller of an estimated call-back time, and a signal flow to further perform the call-back from the provider computer to the caller; and

FIGS. 4A and 4B illustrate a method performed by a provider computer to telephone a caller back at a later time.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electromagnetic signaling techniques, and the like, have been omitted inasmuch as such details are not considered necessary to obtain a complete understanding of the present invention, and are considered to be within the understanding of persons of ordinary skill in the relevant art.

It is further noted that, unless indicated otherwise, all functions described herein may be performed in either hardware or software, or some combination thereof. In a preferred embodiment, however, the functions are performed by a processor, such as a micro-processor, a desktop computer or a mainframe in accordance with code, such as computer program code, software, and/or integrated circuits that are coded to perform such functions, unless indicated otherwise.

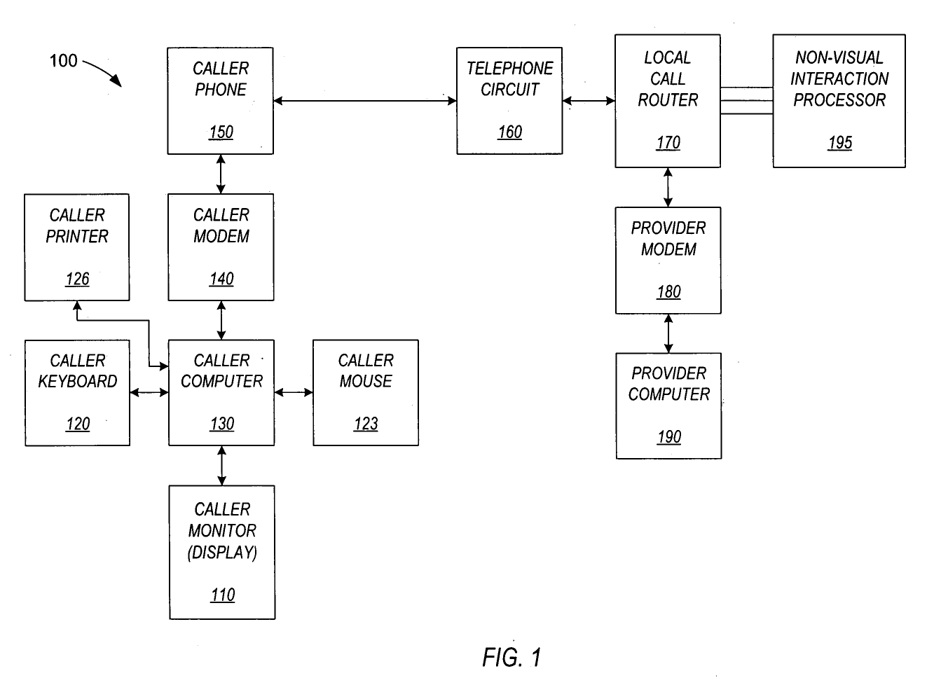

Referring to FIG. 1, the reference numeral 100 generally designates a telephonic system 100. Generally, the system 100 visually presents a hierarchy of menus and menu selections to a caller. This visual presentation of a hierarchy of menus generally enables the caller to evaluate the options and select the appropriate menu choice, or take other appropriate action, without the delay in receiving the options, and negotiating the hierarchy of menus, necessitated by an oral presentation of the menu options. In other words, the caller can visually see an option as a leaf node of a menu decision tree, and react appropriately, without the caller having to wait until being presented with the appropriate option orally.

The system 100 comprises a caller phone 150 and a caller modem 140. The caller modem 140 is coupled to a caller computer 130. The caller computer 130 is coupled to a caller keyboard 120, a caller monitor 110, a caller printer 126, and a caller mouse 123.

The system 100 further comprises a provider computer 190 coupled to a provider modem 180. The provider modem 180 is coupled to a local call router 170. In one embodiment, the local call router 170 is employable to route calls to a plurality of provider computers, personnel or other responders, at least one of which processes phone calls which do not request a visual representation of hierarchical menus, such as the non-visual interaction processor 195. The local call router 170 is coupled to a telephone circuit 160. The telephone circuit 160 can be circuit switched, packet switched, infrastructure for POTS (plain old telephone system), second or third generation (2G or 3G) mobile, and may also include light fiber, or other technologies understood by those of skill in the art. The telephone circuit 160 is connected to both the caller phone 150 and the local call router 170.

In the illustrated embodiment of FIG. 1, a phone call can be placed from the caller phone 150 to the telephone circuit 160 to the local router 170. The telephone circuit 160 adds a “ringing” signal to the phone call, which is discerned by the local call-router 170.

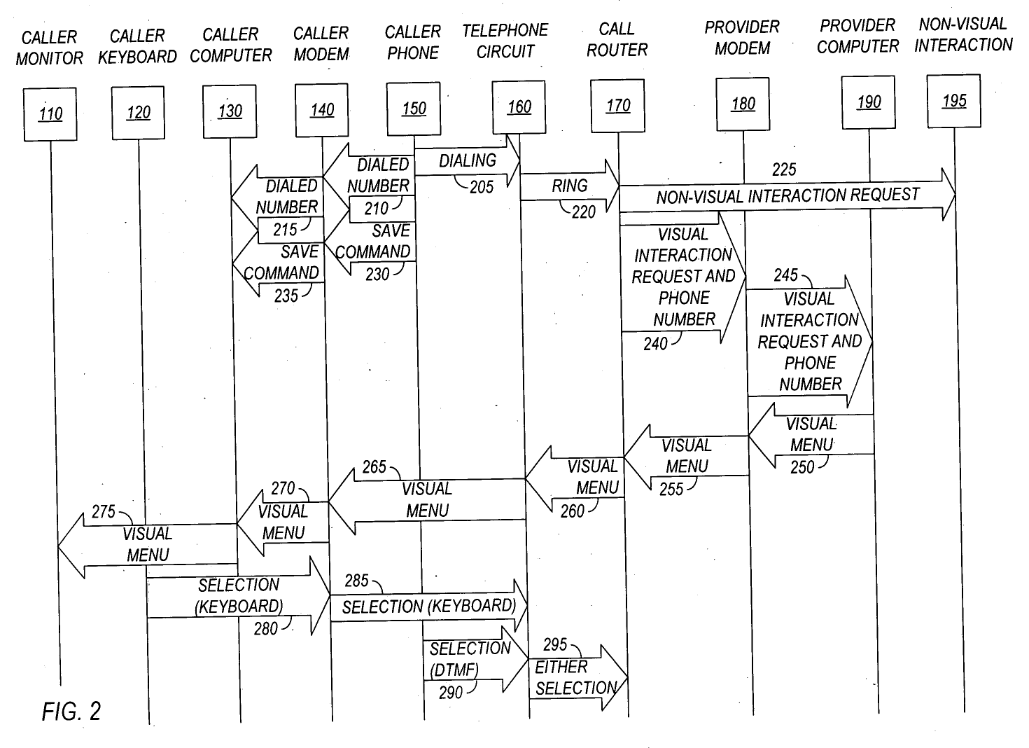

Upon the receipt of the ringing signal, the local call router 170 can send a brief greeting and a prompt for the alternative selection of either an audible or visual response to the caller employing the caller phone 150. In other embodiments, this selection of either an audible or visual response is associated with the original dialing flow 205, as shown in FIG. 2, and the local call router 170 does not send the prompt to select to the caller. In one embodiment, the selection is made by touch tone (DTMF) through employment of the caller. In another embodiment, the caller computer 130 is employable to, automatically or at the instigation of the caller, send a signal that the visual representation of hierarchical menus is to be presented to the caller. In a third embodiment, both the audible and the visual representation of hierarchical menus is to be presented without a selection of either mode by the caller.

If the conventional audible presentation menu is selected by the caller, non-visual interaction 195 menus are selected, and the oral presentation of menus over the caller phone 150 proceeds in a manner understood by those of skill in the art. However, if the caller selects the presentation menu to be a visual display menu, the local call router 170 accesses the provider modem 180 and the provider computer 190. The provider computer 190 then transmits a representation of the hierarchy of menus, or parts thereof, in digital form to the caller modem 140. The modem 140 then forwards the representation of the hierarchy of menus to the caller computer 130, and from there to the monitor display 110. The hierarchy of menus is then displayed visually for the caller, thereby allowing a faster recognition and selection of a menu option by the caller than if the hierarchy of menus were presented orally to the caller.

The caller then responds to the desired option. In one embodiment, the caller keyboard 120 is employed. In another embodiment, touch tone DTMF tones associated with the caller phone 150 are employed. In another embodiment, the caller mouse 123 is employed. In yet another embodiment, the caller gives oral directions based upon visual information that the caller perceives from the display monitor 110. However, those of skill in the art understand that there are other selection methods within the scope of the present invention. In one embodiment, the provider computer 190 and the provider modem 180 comprise an interface system for providing to a telephone caller a visual representation of a hierarchy of one or more menus, each menu having at least one option for selection.

In one embodiment of the system 100, provider software is employed to implement the recognition of a representation of a visual hierarchy of menus, at the request of the caller phone 150, by the provider computer 190. This software is employable in conjunction with the provider computer 190. The provider software employs a modem driver to establish the communication between provider modem 180 and the provider computer 190. The provider software can also enable the transmission of the representation of the visual hierarchy of menus from the provider computer 190 to the caller computer 130. In one embodiment, the representation of the visual hierarchy of menus comprises a computer file. The software also includes the ability to have the hierarchical menu structure adapted or replaced in the provider computer 190. The provider software can also provide protocols for error correction for transmissions between the provider computer 190 and the caller computer 130, proper disconnect procedures, reacting to hang ups by the caller, early selection by the caller, caller override, and so on.

Early selection can be generally defined as making a selection by the caller before the menu is received by the caller; for example, if a caller has prior knowledge of the menu to be presented. Therefore, the caller could make such a selection early, especially if the caller is placing the call through employment of a computer. This early selection can cause a program error from which the provider software must recover. Caller override can comprise overriding an invalid selection by the caller, errors created by the caller not responding within a predetermined length of time, or other events created by the caller or the system 100 that do not precisely follow the anticipated protocol.

In a further embodiment, the system further comprises caller software employable in conjunction with the caller computer 130. The caller software also generally recognizes the placement of a call, and also recognizes when the caller phone 150 selects the visual presentation of the hierarchy of menus. The caller software generally manages the caller modem 140 to transfer communications between the provider computer 190 and the caller computer 130. The caller software further allows for the caller computer 130 to receive and store the representation of the visual hierarchy of menus, and would also allow manipulation of this file, such as page-up, page-down, edit commands, and so on, and provide orderly recovery from errors and unusual commands or responses. Typically, the “edit” command would be used to make notes for future use in a stored menu or to delete. unnecessary or undesirable content.

In a further embodiment, the caller phone 150, the caller modem 140, the caller computer 130, the caller keyboard 120, the mouse 123, and the caller monitor 110 are combined into a single device. In one embodiment, the single device comprises a wireless phone. In another embodiment, a “digital personal assistant,” such as a Palm Pilot®, with the caller software, performs the functionality of devices 110 through 150. In a further embodiment, at least some of the devices 110 through 150 are combined into a wired telephone. In a still further embodiment, two or more devices of 110 through 150 are combined into a unit that is employable with existing equipment the caller has for other purposes. For example, a wired telephone could also have a display integrated within that is employable for both the display of the hierarchy of menus and also for playing computer games.

In the system 100, in a still further embodiment, the transmittal of the visual hierarchy of menus is transparent to the caller. In other words, although the caller can be aware that the hierarchy is requested or presented through the telephone circuit 160 and the caller phone 150, the protocols or signaling energies employed to transmit and receive the visual hierarchy of menus do not pass a threshold of discernability of the senses of the caller.

In one embodiment, the telephone circuit 160 is employable to transmit 24 kilobits (KBs) per second when transmitting representations of a visual hierarchy of menus. At this speed, over 2000 characters per second can be transmitted from the provider computer 190 to the caller computer 130. In one embodiment, only text is transmitted, thereby limiting discomfort to the caller. Generally, the discomfort is caused by the time and sound similar to that of a computer linking up with an Internet provider.

Furthermore, there are “voice over data” methods available to make long transmissions, containing graphics, which are silent to the caller. Generally, “voice over data” is a term to describe the simultaneous transmission of voice and data over the same channel.

In a further embodiment, the caller computer 130 is employable to bypass the greeting that is transmitted by the local call router 170 when a call from the caller phone 150 is placed. The caller computer 130 instead automatically signals its presence to the local call router 170, and therefore to the provider computer 190, so transmission of the representation of the visual hierarchy of menus from the provider computer 190 can begin substantially immediately, with no further intervention on behalf of the caller to receive the representation of the hierarchy of menus required. The local call router 170 has software that allows it to either send the greeting to the caller phone 150 or pass the request for the visual representation of the hierarchy of menus on to the provider computer 190.

In a further embodiment, the caller and provider software allows both text and graphics to be transmitted so illustrations, banners, highlighting, and so on, can be transmitted and displayed. In one embodiment, a text editor is employable by the source computer 170 to navigate the hierarchy of menus and display graphics.

In a further embodiment, caller and provider software saves the received representation of the hierarchical menu of options and associates it with the called number when the number is redialed. Editing the file for comments by the caller, highlighting by the caller, and so on, is provided. Selective refresh can be available. In other words, the representation of the hierarchical menu structure is updated after a predetermined time, or when the provider computer 190 indicates that a newer version of the visual hierarchy of menus is now available.

Often, phone calls can be made to obtain data such as an account balance, another phone number or an email address. In one embodiment, the caller software and the provider software are configurable so that the request for such other data in digital and printable form is available by request from the caller keyboard 120, DTMF associated with the caller phone 150 or caller mouse 123. The printed form is output to the caller printer 126.

In another embodiment, once the called entity, such as the provider computer 190, detects the caller computer 130, the called entity displays a web site type style display to display the visual hierarchy of menus, or the actual web site of the called entity. In a further embodiment, there are forwarded connections to related web sites via the called entity's provided Hyperlink, and Internet connection in the visual presentation of the hierarchy of menus. In a yet further embodiment, the called entity responds with in yet other formats for the visual presentation of the hierarchy of menus.

Turning now to FIG. 2, a Nodal Analysis diagram illustrates a signal flow from a calling phone requesting a visual hierarchical representation of menus.

In flow 205, the caller phone 150 dials a call to the telephone circuit 160. The telephone circuit 160 then sends a ringing signal indicating a message or request to the local call router 170 in flow 220.

The local call router 170 determines whether the telephone call is a request for a visual representation of a hierarchy of menus, or whether the telephone call contains a request for an audio, that is, a non-visual, representation of menus. In an alternative embodiment, a greeting and/or prompt is sent to the caller phone 150 after the local call router 170 receives the call to determine whether the call is a request for a visual hierarchy of menus. If it is a request for a non-visual interaction, the router 170 sends a request to the non-visual interaction source 195 in flow 225, and the audio presentation of menus continues according to conventional non-visual representation technology.

However, if the telephone call contains a request for a visual interaction, this request is forwarded to the provider modem 180 in flow 240. Then, in flow 245, this request is further provided to the provider computer 190.

The provider computer 190 selects which visual menu or visual hierarchy of menus to send the caller, and then sends a digital representation of the menu back to the provider modem 180 in flow 250. The visual menu of hierarchy of menus (in digital form) is sent to the call router 170 in flow 255, and from there to the telephone circuit 160 in flow 260.

In flow 265, the digital information representing the visual hierarchical menu is sent to the caller modem 140. From the caller modem 140, in flow 270, the digital information is sent to the caller computer 130. The digital information is then processed by the caller computer 130, and transmitted to the caller monitor 110 in flow 275. In one embodiment, the modem 140 receives the dialed number as it is dialed and then forwards it to the caller computer 130 in flow 215, which saves it. Generally, saving the number enables the caller computer 130 to automatically recognize that a given dialed number is associated with a particular visual representation of hierarchical menus, thereby enabling its recall whenever the number is re-dialed, saving computer time to receive the digital information again. The save function also allows association of the file with other information, such as name, product, and so on, as well as the number.

In an alternative embodiment, the caller computer 130 can notify the local call router 170 that the dialed number is associated with a visual interaction request, thereby avoiding the time associated with the caller responding to a greeting from the local call router 170, or the time associated with the caller otherwise indicating to the local call router 170 of his or her choice of a visual interaction request. In a further embodiment, the local call router 170 is employable to select and send both the audible and visual data from the provider computer, without any selection or prompting at the caller end. The caller can then separate the desired information and discard the other information.

The caller can make the appropriate selection of a menu option after visually perceiving the visual hierarchical menu. In one embodiment, the keyboard data is first input through the caller computer 130 and then to the modem 140. This selection is then passed from the caller modem 140 to the telephone circuit 160. In a further embodiment, the caller can also employ the caller mouse 123.

In an alternative embodiment, the caller employs the caller phone 150 to convey menu selections through DTMF tones in data flow 290. However, the menu selections are chosen through the employment of the visual. representation of hierarchical menus from the caller monitor 110. In either embodiment, the selections are forwarded back to the call router 170 in data flow 295.

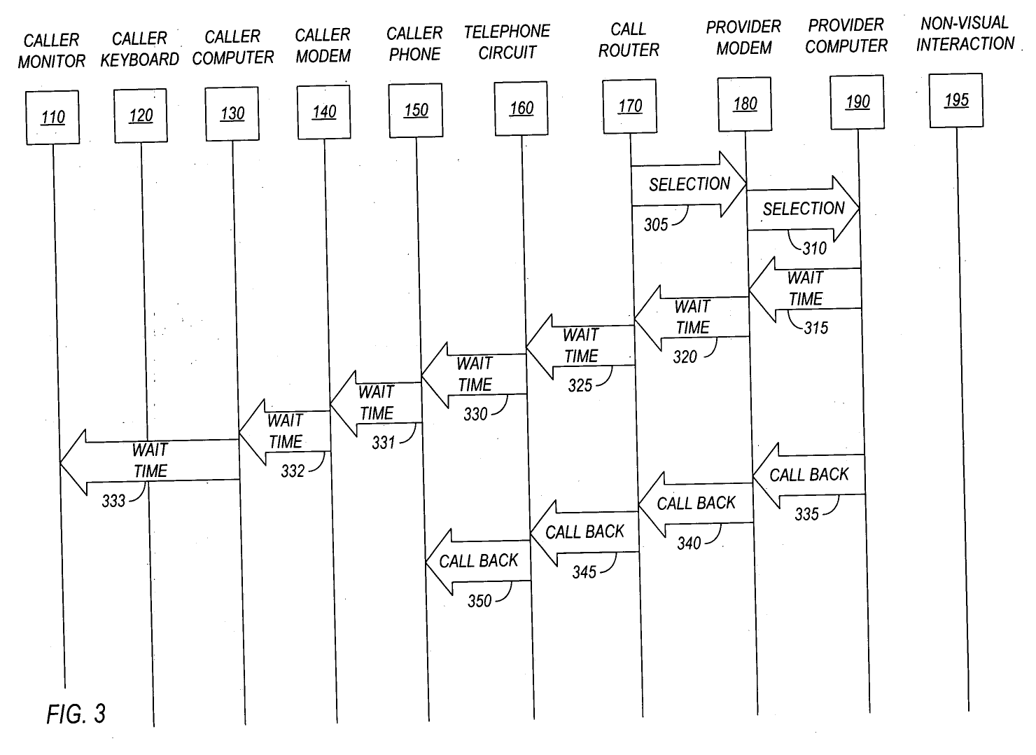

Turning now to FIG. 3, disclosed is a nodal analysis of a signal flow between the caller phone 150 and the provider computer 190. Generally, in FIG. 3, the caller is in a situation wherein, in conventional automated telephone systems, he or she would be put on hold or disconnected. In FIG. 3, at the selection of the caller, the provider computer 190 instead telephones the caller back at a time determined to minimize the wait time of the caller. The provider computer 190 determines the telephone number of the caller, or otherwise has the caller input the telephone number of the caller telephone into the provider computer 190. Alternatively, the caller can input a telephone number of a telephone other than the caller phone. The provider computer 190 telephones the caller back at the appropriate time. The appropriate time can be when the provider computer 190 can service the caller without the caller waiting in an interaction request queue.

In one aspect, the caller is informed by the provider computer 190 approximately how long he or she should be waiting before receiving a return call back from the provider computer, and is given the option of waiting in the interaction request queue of the provider computer 190 or being called back by the provider computer 190. Whether the caller is given the option to select to be called back by the provider computer 190, or, alternatively, the provider computer 190 makes that determination for the caller, can be a function of the number of callers in the interaction request queue of the provider computer 190, the estimated conversation time of each caller in the interaction request queue, and so on. Those of skill in the art understand, however, that these are examples of waiting algorithms that can be used in the system 100 and flow diagram 200, and that other waiting/queuing time calculations and algorithms are within the scope of the present invention.

In FIG. 3, a selection of a visual or non-visual interaction request is sent from the call router 170 to the provider modem 180 in flow 305. The selection request is sent from the provider modem 180 to the provider computer 190 in flow 310.

The provider computer 190 determines that the caller can not be immediately serviced by the provider computer 190. Therefore, the provider computer 190 calculates an approximate wait time in which the caller should either be serviced after waiting in the interaction request queue, or alternatively, the time at which the caller is to be called back by the provider computer 190. Either or both of these estimations are sent from the provider computer 190 to the provider modem 180 in flow 315. The estimated wait time is sent from the provider modem 180 to the call router 170 in flow 320. The estimated wait time is sent from the call router 170 to the telephone circuit 160 in flow 325, and to the caller phone 150 in flow 330 and is displayed on the caller monitor (display) 110 and/or spoken to the caller over the caller phone 150 through flows 331, 332 and 333.

In FIG. 3, the provider computer 190 disconnects the telephone circuit between the caller phone 150 and the provider computer 190. This can be the decision of the caller phone 150, or the provider computer 190, as appropriate.

In either event, the provider computer 190 calls the caller phone 150 at a later time. Typically, this later time is when the provider computer 190 can service the caller without putting the caller on hold. The provider computer sends a call back command to the provider modem 180 in signal flow 335. From the provider modem 180, the call back command is sent to the call router 170 in flow 340. From the call router 170, the call back command is sent to the telephone circuit 160 in flow 345. The telephone circuit then telephones the caller phone 150 in flow 350.

The flows 335, 340, 345 and 350 enable the provider computer 190 to service the caller phone 150 without the caller waiting on-hold in an interaction request queue at the provider computer 190. Instead, the provider computer 190 telephones the caller when the provider computer 190 is able to service the caller, thereby allowing the caller to be previously disconnected from the provider computer 190 without losing his or her place in a service queue. The service queue can generally be defined as the aggregate queue of those callers who are both connected to the provider computer 190 and waiting servicing and any disconnected callers that are waiting for a call back from the provider computer 190. The queue in which the caller waits to be called back is the callback queue.

In one aspect of FIG. 3, the caller is informed that the provider computer 190 will phone him or her back during a specified time window. In other words, the caller is told that the provider computer 190 will phone between a designated start time and a designated end time. The designated start and end times can be based upon predictions of the provider computer 190 as to when it will be finished servicing the service queue. Alternatively, the caller can be informed that he or she shall be phoned a specific time. The specific time is based upon predictions of the provider computer 190 as to when it will be finished servicing the service queue.

In a still further aspect of FIG. 3, the caller can be told that the provider computer 190 will phone at a certain or specified time, but that this time is approximate within a given variance. In other words, the caller is made aware that the call back time is a target time, but that there can be an explicit amount of known variation in the call back both before and after the target call back time. In a yet further embodiment, the caller can be told that the computer will phone using any of the above approaches (time window, exact time, approximate time with explicit variance), but that this is only a projected call back time, and that the provider computer will phone when it is able to.

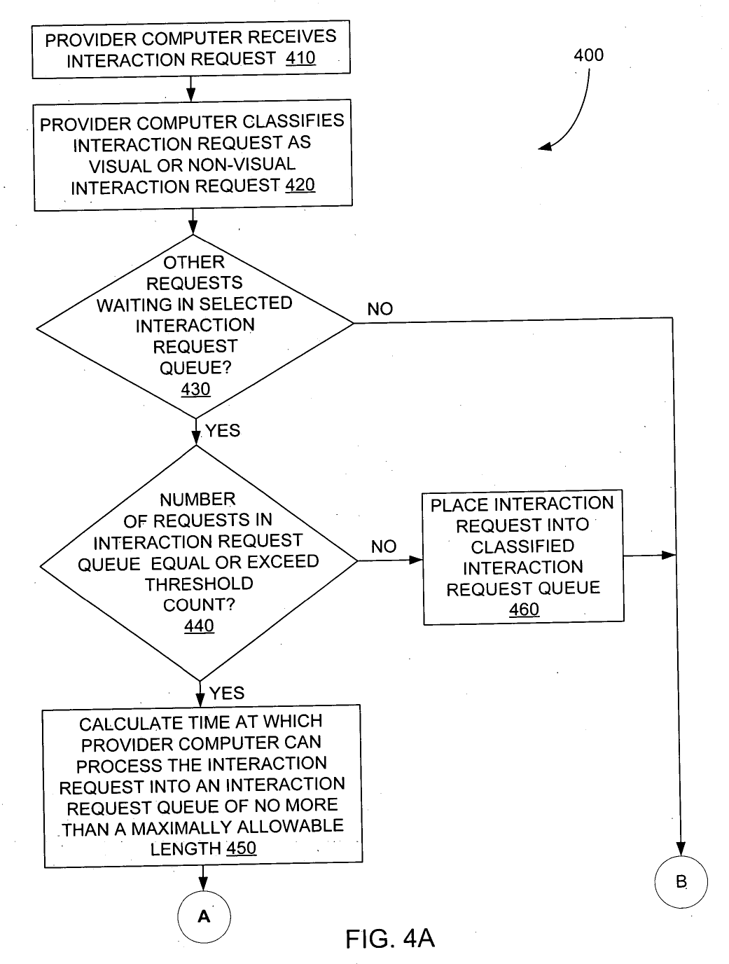

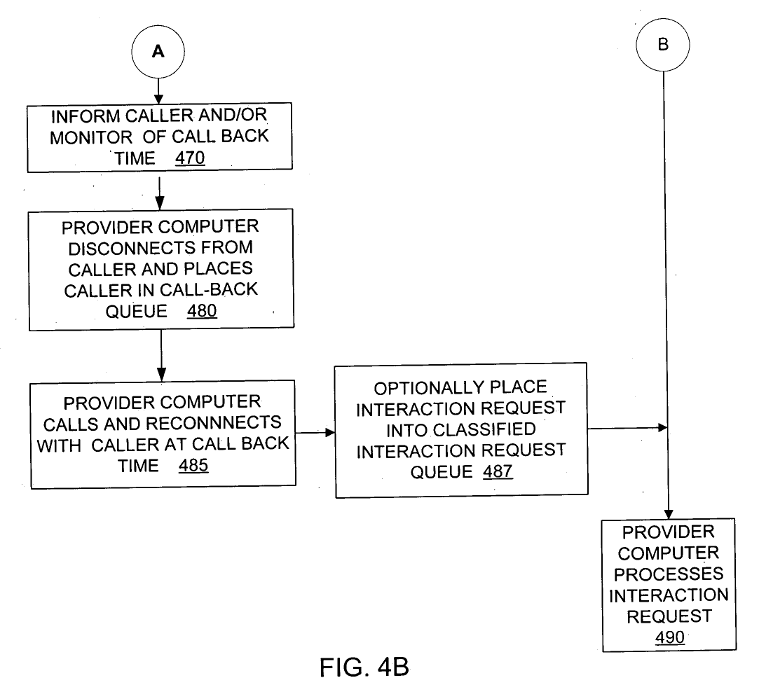

Turning now to FIGS. 4A and 4B, illustrated is a method 400. The method 400 generally pertains to receiving and processing an interaction request, and determining whether a provider computer is to disconnect the call, and then call the caller back at a later time.

In step 410, the provider computer receives an interaction request. In step 420, the provider computer classifies the interaction request as either a visual or non-visual interaction request.

In step 430, the provider computer determines if other requests are waiting in the selected request queue (that is, the visual or non-visual interaction request queue, as classified in step 420). If no other requests are waiting in the selected interaction request queue, this means that the provider computer can typically process this type of interaction request (visual or non-visual) expeditiously. Therefore, in step 490, the provider computer processes the classified interaction request.

However, if there is at least one other interaction request already queued in the selected interaction request queue, then the provider computer determines whether the number of interaction requests equal or exceed a threshold count. In other words, if there is at least one interaction request in the interaction request queue, the provider computer determines whether the number in the interaction request queue is equal or greater than a defined value. The threshold value can be predefined, or the provider computer can change or update the threshold value as a function of the average time to complete an interaction request, available capacity of the provider computer, and so on. If the selected interaction request queue is less than the maximum length allowable for the queue, in step 460 the provider computer places the classified interaction request into the classified interaction request queue. The provider computer processes interaction requests in the interaction request queue in the order of the queue. In step 490, the provider computer processes the interaction request.

However, if the number of interaction requests equals or exceeds a specified threshold, in step 450, the provider computer calculates or estimates the time or a time window at which the selected interaction queue, if no other interaction requests are placed within the interaction request queue, will be at a defined maximally allowable length. Typically, the defined maximally allowable length of step 450 is shorter than the threshold count of step 440.

In step 470, the provider computer informs the originator of the interaction request of the calculated or estimated call back time or call back time window. The call back time or call back time window was calculated in step 450. The call back time is when the provider computer will phone the caller back (that is, reconnect with the caller), and allow the provider computer to continue to process the interaction request in a timely fashion.

In step 480, the provider computer disconnects from the caller and places the interaction request in a call-back queue, along with its associated call back time. Within the call-back queue, the caller is to be called back at the calculated or estimated time, as determined in step 450. In step 487, the interaction request can optionally be transferred into the interaction request queue, to be later processed by the provider computer in step 490. Alternatively, the interaction request is processed by the provider computer in step 490 without the interaction request being first placed into the interaction request queue.

It is understood that the present invention can take many forms and embodiments. Accordingly, several variations may be made in the foregoing without departing from the spirit or the scope of the invention.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

What is claimed is:

1. A system for providing a telephone caller response and option selection, comprising:
an interface system for providing to a telephone caller a visual representation of a hierarchy of one or more menus, each menu having at least one option for selection, the interface system further employable to disconnect from the caller and to reconnect to the caller at a later point in time;
a caller phone employable to select at least one option from the visual representation of a hierarchy of menus provided by the telephone interface system;
a caller computer employable to receive the visual representation of a hierarchy of menus from the interface system; and
a caller monitor employable to display the visual representation of a hierarchy of menus.

2. The system of claim 1, wherein the interface system is configured to disconnect from the caller and to contact the caller at a later time if a provider computer interaction request queue exceeds a specified threshold.

3. The system of claim 2, wherein the interface system is configured to disconnect from the caller and to contact the caller at a later time if the caller so indicates.

4. The system of claim 1, further comprising a caller computer input device employable to respond to the display of the hierarchy of menus.

5. The system of claim 4, wherein the caller computer input device comprises a keyboard.

6. The system of claim 4, wherein the caller input device comprises a mouse.

7. The system of claim 1, further comprising a local call router interposed between the caller computer and the interface system.

8. The system of claim 6, wherein the local call router is employable to route calls configured for the visual presentation of the hierarchy of menus.

9. The system of claim 7, wherein the local call router is employable to route calls configured for the oral presentation of the hierarchy of menus.

10. The system of claim 1, further comprising a printer coupled to the caller computer.

11. The system of claim 1, wherein the caller phone, the caller monitor and the caller computer are integrated into one unit.

12. The system of claim 1, wherein the representation of the visual hierarchical menu structure comprises a computer file.

13. The system of claim 1, wherein the caller computer is employable to modify the presentation of the visual hierarchical menu structure.

14. The system of claim 1, wherein the caller computer is employable to perform a selective refresh upon the visual hierarchical menu structure.

15. The system of claim 1, wherein the caller computer is employable to associate a called number with a visual hierarchical menu structure.

16. The system of claim 1, wherein the interface system comprises a provider computer.

17. A method of telephonic communication, comprising:
transmitting an interaction request;
if the interaction request is placed in an interaction request queue of a provider computer, determining whether to disconnect from the originator of the interaction request and to further contact the originator of the interaction request when the interaction request is in a queue of less than a threshold count;
determining whether the interaction request is a visual or non-visual interaction request;
if the request is a visual interaction request, responding to the visual interaction request; and
if the request is a visual interaction request, transmitting a representation of a hierarchy of menus.

18. The method of claim 17, further comprising a determination by the provider computer as to whether the caller is to be telephoned at a later time instead of waiting in the interaction request queue of the provider computer.

19. The method of claim 17, further comprising a determination by a caller as to whether the caller is to be telephoned at a later time instead of waiting in the interaction request queue of the provider computer.

20. The method of claim 19, wherein to be telephoned at a later time further comprises a time window.

21. The method of claim 17, further comprising responding to the representation of the hierarchy of menus by the caller.

22. The method of claim 17, wherein the step of transmitting an interaction request is transmitted by the caller computer.

23. The method of claim 17, wherein the step of transmitting an interaction request is transmitted by the caller.

24. The method of claim 17, wherein transmitting a representation of a hierarchy of menus further comprises transmitting text and graphics.

25. A provider system for employment with transmitting a visual hierarchy of menus, comprising:
a local call router, configured to determine whether a call is a request for a visual interaction or a request for non-visual interaction;
a provider computer, configured to transmit a representation of a requested visual hierarchy of menus and further configured to disconnect the call and to reconnect to the originator of the call at a later time if a wait time for the call within an interaction request queue of the provider system exceeds a specified threshold; and
a non-visual interaction provider, configured to transmit a requested non-visual representation of a hierarchy of menus.

26. A caller system for employment in requesting and receiving a visual hierarchy of menus from a provider computer, comprising:
a caller source, configured to request either a visual interaction or a non-visual interaction, and further configured to request a call back from the provider computer if the request of the visual interaction or non-visual interaction is stored in an interaction request queue at the provider computer, and that queue exceeds a threshold;
a caller computer, configured to receive the representation of the visual hierarchy of menus; and
a caller monitor, employable to display the visual hierarchy of menus.

27. The caller system of claim 26, further comprising a means for selecting an option within the visual hierarchy of menus.

28. The caller system of claim 26, wherein the visual interaction employs a visual hierarchy of menus.

29. The caller system of claim 26, wherein the caller source comprises a caller phone.

30. A system for providing caller response and option selection, comprising:
an interface system for providing to a caller both an oral and a visual representation of a hierarchy of one or more menus, each menu having at least one option for selection, the interface system further configured to call the caller or a designated other person back at a later time if an interaction request queue time for a request of a visual or oral representation of a hierarchy of one or more menus exceed a specified threshold;
a display device for rendering to the telephone caller the visual representation of the hierarchy of menus; and
a caller response device employable to select at least one option in response to either the oral or the visual representation of a hierarchy of menus provided by the interface system.

31. The system of claim 30, wherein the response device comprises a telephone.

32. A system for returning a call, comprising:
a provider computer configured to disconnect from a caller when a call is stored within an interaction request queue of the provider computer for at least a specified length of time, the provider computer further configured to reconnect to the caller after a period of time elapses.

33. The system of claim 32, wherein the provider computer is further configured to generate indicia for a caller as to an approximated time that the provider computer will reconnect to the caller.

34. The system of claim 32, wherein the provider computer is further configured to generate indicia for a caller as to a time window in which the provider computer will reconnect to the caller.

35. The system of claim 32, wherein the provider computer is further configured to place the interaction request into a service queue.

36. A method of returning a call, comprising:
receiving an interaction request at a provider computer;
determining a wait time for when the interaction request can be serviced;
if the interaction request can not be serviced during a given time threshold:
sending the wait time to the originator of the interaction request;
disconnecting the originator of the interaction request and the provider computer;
reconnecting to the originator of the interaction request and the provider computer at a later time; and
responding to the interaction request at the later time.

37. The method of claim 36, further comprising putting the interaction request into a service queue.

38. The method of claim 37, further comprising putting the interaction request into a callback queue.
